(19) United States
(12) Patent Application Publication
(10) Pub. No.: US 2009/0215012 A1
(43) Pub. Date: Aug. 27, 2009

(54) TRAINING SYSTEM FOR CARD GAMES

(76) Inventor: Kyle T. Ressler, West Bend, WI (US)

Correspondence Address: MICHAEL BEST & FRIEDRICH LLP, Two Prudential Plaza, 180 North Stetson Avenue, Suite 2000, CHICAGO, IL, 60601, US

(21) Appl. No.: 12/390,987

(22) Filed: Feb. 23, 2009

Related U.S. Application Data
(60) Provisional application No. 61/031,185, filed on Feb. 25, 2008.

(51) Int. Cl. G09B 19/22

(52) U.S. Cl. 434/129

(57) ABSTRACT

A set of training cards provide information and statistics related to various combinations of hands in games involving standard playing cards, such as Texas Hold'em poker. For example, one side of the card includes a first hole card region, a first flop card region, and a first turn card region. Indicia located in these regions represent a set of hole cards, flop cards, and a turn card, respectively. A second side of the card includes a second hole card region, a second flop card region, and a second turn card region. Indicia located in these regions represent the same set of hole cards, flop cards, and turn card, respectively. A hole rank region, a flop odds region, a turn odds region, a turn/river odds region, a river odds region, and first and second nut hand regions provide relative strengths, probabilities and statistics corresponding to the indicia shown.

### CROSS-REFERENCE TO RELATED APPLICATIONS

This application claims the benefit of and priority to U.S. Provisional Patent Application No. 61/031,185 entitled “TRAINING SYSTEM FOR CARD GAMES” and filed Feb. 25, 2008, the entire contents of which are hereby incorporated by reference.

### BACKGROUND

The present invention relates generally to training aids, and more specifically to training aids for games involving playing cards, such as poker.

Training aids, such as flash cards, are used to memorize facts. Typically, a set of flash cards has a question on one side and an answer on the other. A person using the flash cards can test themselves by reading the question, guessing the answer, and checking the answer on the back of the card.

### SUMMARY OF THE INVENTION

In some embodiments, the invention provides a set of training cards for learning the relative strength of hands in a card game. The set of training cards includes a plurality of cards, each card having a first side and a second side. The first side of each card includes a first hole card region including indicia corresponding to a pair of hole cards, a first flop card region including indicia corresponding to three flop cards, and a first turn card region including indicia corresponding to a turn card. The second side of each card includes a second hole card region including the indicia corresponding to the pair of hole cards, a hole hand rank portion, and a flop hand odds portion. The second side of each card also includes a second flop card region including the indicia corresponding to the three flop cards, a flop nut hand portion, a turn hand odds portion, and a turn/river hand odds portion. The second side of each card also includes a second turn card region including the indicia corresponding to the turn card, a turn nut hand portion, and a river hand odds portion. Each of the plurality of cards includes indicia corresponding to different combinations of hole cards, flop cards, and turn cards.

In some embodiments, the invention provides a set of training cards for learning the relative strength of hands in a card game. The set of training cards includes a plurality of cards, each card having a first side and a second side. The first side of each card includes a first hole card region including indicia corresponding to a hole card, a first flop card region including indicia corresponding to a flop card, and a first turn card region including indicia corresponding to a turn card. The second side of each card includes a second hole card region including the indicia corresponding to the hole cards and a flop hand odds portion. The second side of each card also includes a second flop card region including the indicia corresponding to the flop card, a turn hand odds portion, and a turn/river hand odds portion. The second side of each card also includes a second turn card region including the indicia corresponding to the turn card and a river hand odds portion. Each of the plurality of cards includes indicia corresponding to different combinations of hole cards, flop cards, and turn cards.

In some embodiments, the invention provides a set of training cards for learning the relative strength of hands in a card game. The set of training cards includes a plurality of cards, each card having a first side and a second side. The first side of each card includes a first hole card region including indicia corresponding to at least one hole card, and a dealt card region including indicia corresponding to at least one dealt card. The second side of each card includes a second hole card region including the indicia corresponding to the at least one hole card and a dealt hand odds portion. The second side of each card also includes a second dealt card region including the indicia corresponding to the at least one dealt card and an additional dealt card odds portion. Each of the plurality of cards includes indicia corresponding to different combination of hole cards and dealt cards.

### BRIEF DESCRIPTION OF THE DRAWINGS

FIG. 1 is a front view of a training card for a playing card game, the training card illustrated with generic indicia.

FIG. 2 is a back view of the training card of FIG. 1.

Before at least one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways.

### DETAILED DESCRIPTION

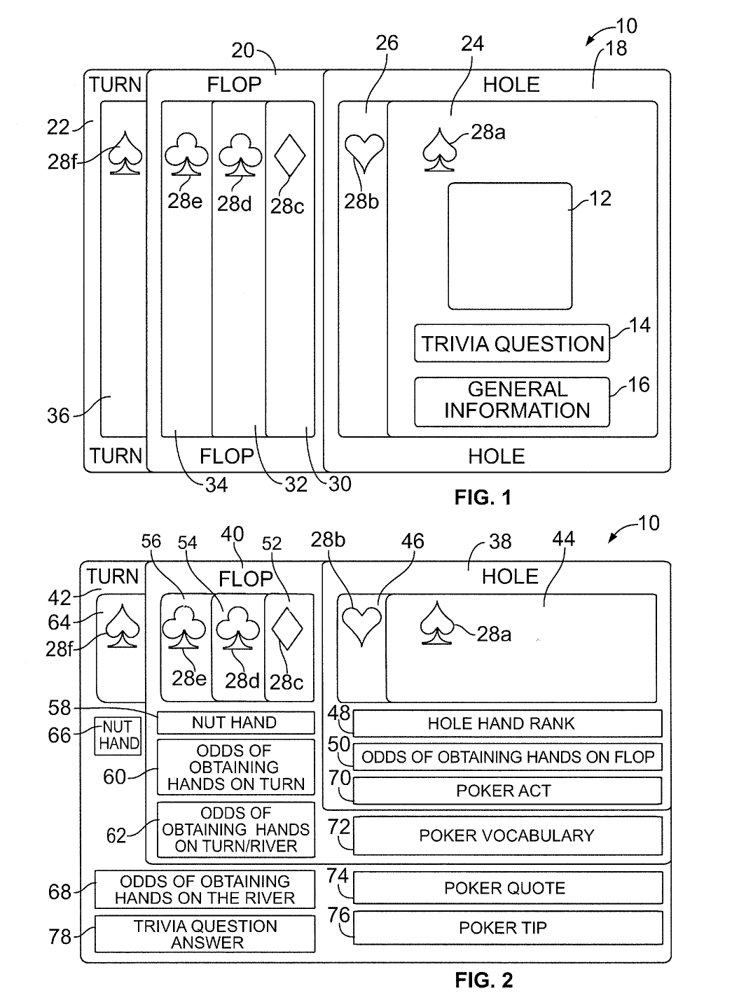

FIG. 1 illustrates the front of a training card 10 for the game of poker. More specifically, the training card 10 is specifically configured to assist a user in understanding the various odds and probabilities associated with potential hands in the Texas Hold'em poker game (hereafter “the game”). It should be appreciated however that the concepts, configurations, and methods underlying the presentation of information on the training card 10 can also be applied to other types and variations of poker games. The front of the training card 10 generally includes a logo region 12, a trivia question region 14, a disclaimer/general information region 16, a first hole region 18, a first flop region 20, and a first turn region 22. The logo region 12 provides a space for a logo, such as a manufacturer's logo. The trivia question region 14 provides a space for a trivia question to be printed. The disclaimer/general information region 16 provides a space for a disclaimer or general information, such as a website or contact information.

The first hole region 18 includes first and second card regions 24, 26, which represent two playing cards from a standard deck of playing cards. The first hole region 18 simulates a player's view of the hole cards, which, in Texas Hold'em, are the two playing cards dealt face down directly to the player prior to the placement of any bets (other than ante) by the players. The first and second card regions 24, 26 include respective first and second indicia 28a, 28b from a standard playing card. The indicia 28a, 28b may represent a suit such as a club, a diamond, a spade, or a heart, for example. Indicia representing the number or rank of the card, such as the numbers 2 through 10 and the letters J, Q, K, and A, are also included but not illustrated in FIG. 1.

The first flop region 20 includes third, fourth and fifth card regions 30, 32, 34, which represent three playing cards from a standard deck of playing cards. The first flop region 20 simulates a player's view of the flop, which, in the Texas Hold'em poker game, is a set of three playing cards dealt face up (e.g., “community cards”) after completion of a first round of betting based on each player's hole cards. The third, fourth and fifth card regions 30, 32, 34 include respective third, fourth and fifth indicia 28c, 28d, 28e from three standard playing cards. The indicia 28c, 28d, 28e may represent a suit such as a club, a diamond, a spade, or a heart, for example. Indicia representing the number or rank of the card, such as the numbers 2 through 10 and the letters J, Q, K, and A, are also included but not illustrated in FIG. 1.

The first turn region 22 includes a sixth card region 36, which represents a playing card from a standard deck of playing cards. The first turn region 22 simulates a player's view of the turn card, which, in Texas Hold'em, is a single playing card dealt face up (e.g., a “community card”) after completion of a second round of betting based on each players hole cards and the previously-dealt community cards (e.g., those from the flop). In Texas Hold'em, the turn card represents the next-to-last community card that will be dealt, and is therefore the last opportunity for a player to bet or fold a hand before all available community cards have been revealed. The sixth card region 36 includes sixth indicia 28f from a standard playing card. The indicia 28f may represent a suit such as a club, a diamond, a spade, or a heart, for example. Indicia representing the number or rank of the card, such as the numbers 2 through 10 and the letters J, Q, K, and A, are also included but not illustrated in FIG. 1.

As illustrated in FIG. 1, the first and second card regions 24, 26 of the first hole region 18 are illustrated in overlapping fashion, that is, only the left portion of the second card region 26 is visible, the remainder being obscured by the overlapping first card region 24. In this way, the first and second card regions 24, 26 generally resemble a pair of overlapping playing cards as they would appear when held in the hand or set on a flat surface. The third, fourth, and fifth card regions 30, 32, and 34 of the first flop region 20 are similarly illustrated in overlapping fashion. Furthermore, the first hole region 18 is illustrated as overlapping the first flop region 20, which in turn is illustrated as overlapping the first turn region 22. In this way the first, second, third, fourth, fifth, and sixth card regions 24, 26, 28, 30, 32, 34, and 36 generally resemble playing cards as they would appear when held in the hand or set on a flat surface. As illustrated, the entire left edge (e.g., from top to bottom) of each of the card regions 24, 26, 28, 30, 32, 34, and 36 on the front of the training card 10 is visible. Furthermore, the first hole region 18, the first flop region 20, and the first turn region 22 each extend from a top edge to a bottom edge of the card 10.

FIG. 2 illustrates the back of the training card 10. The back of the training card 10 generally includes a second hole region 38, a second flop region 40, and a second turn region 42. The second hole region 38 at least partially corresponds to the first hole region 18. The second hole region 38 includes seventh and eighth card regions 44, 46, which correspond to the first and second card regions 24, 26, respectively. The seventh and eighth card regions 44, 46 include the same individual indicia as the first and second card regions 24, 26, respectively. That is, the seventh and eighth card regions 44, 46 include the first and second indicia 28a, 28b, respectively. For example, if the first card region 24 includes a club, then the seventh card region 44 also includes a club, as illustrated in FIGS. 1 and 2.

Additionally, the second hole region 38 generally includes a hole hand rank region 48 and a flop odds region 50. The hole hand rank region 48 includes information related to the strength of the hole hand represented by the first and second 24, 26 (and seventh and eighth 44, 46) card regions. For example, the hole hand rank region 48 may include a numerical rank, such as “10” or “19,” and/or a written rank, such as “very good,” “good,” “bad,” or “very bad.” The flop odds region 50 includes information related to the player's odds of obtaining a certain hand on the flop (e.g., with the addition of three random community cards from a standard deck, dealt face up). Knowing the suit and rank of the two hole cards, the odds of obtaining various hands on the flop are calculable. For example, the flop odds region 50 may include the odds of obtaining a pair, two pair, three of a kind, a straight, a flush, a full house, and four of a kind on the flop, based on knowledge of the hole cards. Odds may be written as percentages (e.g., “26.94%”) and/or probabilities (e.g., “1 in 4”).

The second flop region 40 at least partially corresponds to the first flop region 20. The second flop region 40 includes ninth, tenth and eleventh card regions 52, 54, 56, which correspond to the third, fourth and fifth card regions 30, 32, 34, respectively. The ninth, tenth and eleventh card regions 52, 54, 56 include the same indicia as the third, fourth and fifth card regions 30, 32, 34, respectively. That is, the ninth, tenth and eleventh card regions 52, 54, 56 include the third, fourth and fifth indicia 28c, 28d, 28e, respectively. For example, if the third card region 30 includes a heart, then the ninth card region 52 also includes a heart, as illustrated in FIGS. 1 and 2.

Additionally, the second flop region 40 includes a first nut hand region 58, a turn odds region 60, and a turn/river odds region 62. The first nut hand region 58 includes indicia representing the suit and rank of two standard cards—particularly, the nut hand. The nut hand generally refers to the best possible hole hand that another player may be holding. In this situation, the nut hand is the two cards that, in combination with the three flop cards shown in the flop card region, provide the most highly ranked five-card hand possible. The two cards in the nut hand are selected from the cards known to be located either in the remaining deck of cards or in the hole hand of another player. In other words, the nut hand is known to be composed of cards that are neither the flop cards represented in the flop region 20 or 40, nor the hole cards represented in the hole region 18 or 38 (unless the hole cards represented in the hole region are the nut hand).

The turn odds region 60 includes information related to the player's odds of obtaining a certain hand on the turn (e.g., with the addition of a fourth random community card from a standard deck, dealt face up). Knowing the suit and rank of the two hole cards and the three flop cards, the odds of obtaining hands on the turn are calculable. For example, the turn odds region 60 may include the odds of obtaining a pair, two pair, three of a kind, a straight, a flush, a full house, and four of a kind on the turn, based on knowledge of the hole cards represented in the hole region 18 or 38 and the flop cards represented in the flop region 20 or 40. Odds may be written as percentages (e.g., “26.94%”) and/or probabilities (e.g., “1 in 4”).

The turn/river odds region 62 includes information related to the player's odds of obtaining a certain hand on the turn or the river, based on knowledge of only the two hole cards and the three flop cards. The river refers to a fifth and final community card from a standard deck that is dealt face up. Knowing the suit and rank of the two hole cards and the three flop cards, the odds of obtaining hands on either the turn or the river are calculable. For example, the turn/river odds region may include the odds of obtaining a pair, two pair, three of a kind, a straight, a full house, and four of a kind on either the turn or the river, based on knowledge of the hole cards represented in the hole region 18 or 38 and the flop cards represented in the flop region 20 or 40. Odds may be written as percentages (e.g., “26.94%”) and/or probabilities (e.g., “1 in 4”).

The second turn region 42 at least partially corresponds to the first turn region 22. The second turn region 42 includes a twelfth card region 64, which corresponds to the sixth card region 36. The twelfth card region 64 includes the same indicia as the sixth card region 36. That is, the twelfth card region 64 includes the sixth indicia 28f. For example, if the sixth card region 36 includes a heart, then the twelfth card region 64 also includes a heart, as illustrated in FIGS. 1 and 2.

Additionally, the second turn region 42 includes a second nut hand region 66 and a river odds region 68. The second nut hand region 66 includes indicia representing the suit and rank of two standard cards—particularly, the nut hand. The nut hand generally refers to the best possible hole hand that a player may be holding. In this situation, the nut hand is the two cards that, in combination with any three of the four cards shown in the turn region and the flop region, provide the most highly ranked five-card hand possible. The two cards in the nut hand are selected from the cards known to be located either in the remaining deck of cards or in the hole hand of another player. In other words, the nut hand is known to be composed of cards that are neither the turn card represented in the turn region 22 or 42, the flop cards represented in the flop region 20 or 40, nor the hole cards represented in the hole region 18 or 38 (unless the hole cards represented in the hole region are the nut hand).

The river odds region 68 includes information related to the player's odds of obtaining a certain hand on the river, based on knowledge of the two hole cards, the three flop cards, and the turn card. The river refers to a fifth and final community card from a standard deck that is dealt face up. Knowing the suit and rank of the two hole cards, the three flop cards, and the turn card, the odds of obtaining various hands on the river are calculable. For example, the river odds region may include the odds of obtaining a pair, two pair, three of a kind, a straight, a flush, a full house and a four of a kind on the river, based on knowledge of the hole cards represented in the hole region 18 or 38, the flop cards represented in the flop region 20 or 40, and the turn card represented in the turn region 22 or 42. Odds may be written as percentages (e.g., “26.94%”) and/or probabilities (e.g., “1 in 4”).

Also shown in FIG. 2, the training card 10 includes a fact region 70, a vocabulary region 72, a quote region 74, a tip region 76, and a trivia answer region 78. The fact region 70 may include, for example, a poker-related fact. The vocabulary region 72 may include, for example, a poker-related vocabulary word and a corresponding definition. The quote region 74 may include, for example, a quotation taken from a poker player or a poker-related movie or book. The tip region 76 may include, for example, a useful poker-related tip to improve one's playing and understanding of the game. The trivia answer region 78 includes an answer corresponding to the trivia question printed in the trivia question region 14 on the front of the training card 10. These regions may be positioned anywhere on the training card 10.

The appearance of certain information on the second side of the card illustrated in FIG. 2 is similar to that shown in FIG. 1. Specifically, the seventh, eight, ninth, tenth, eleventh, and twelfth card regions 44, 46, 52, 54, 56, and 64 resemble overlapping upper left hand portions of standard playing cards. Unlike the card regions 24, 26, 30, 32, 34, and 36 on the first side of the card, which appear to illustrate the entire left edge of a standard playing card, the card regions 44, 46, 52, 54, 56 and 64 illustrate only the upper left hand portions of a standard playing card because the information in the second hole card region 38, the information in the second flop card region 40, and the information in the second turn card region 42 appears to overlie the remaining portions of the standard playing cards. As also illustrated in FIG. 2, to provide additional space for certain information (e.g. the poker vocabulary 72 and poker quote 74), a portion of the second flop card region 40 extends below the second hole card region 38, and a portion of the second turn card region 42 extends below the second flop card region 40 and the second hole card region 38

It is to be understood by those skilled in the art that there are many possible hole hands, flops and turns that may be represented by the training card 10 in various combinations. Accordingly, the hole rank 48, odds 50, 60, 62, 68, and nut hand 58, 66 regions will vary according to which cards are represented. Preferably, a set of various training cards 10 is provided in accordance with the present invention. The set may include some or all possible combinations of holes, flops and turns and their corresponding ranks, odds and nut hands. The other regions of the training card 10 described above are also subject to variations and are provided as examples only.

In alternate embodiments, the above described training card 10 may be adapted to facilitate learning the relative hand strengths for other card games, including Omaha, 7-card draw, 7-card stud, 5-card draw, and the like. Moreover, the terms hole cards, flop cards, turn card, and river card, which are terms generally associated with Texas Hold'em, should not be construed as limiting with respect to the order and quantity of cards that may be dealt in any particular game. It should be appreciated that additional or fewer card regions and additional or fewer regions such as the hole, flop and turn regions may be included on the training card 10 to correspond to the game play of card games other than the Texas Hold'em card game presented as an example in the foregoing description.

Practically speaking, it is difficult for an ordinary individual to learn all of the information available in the hole rank 48, odds 50, 60, 62, 68, and nut hands 58, 66 regions at one time. Therefore, in some embodiments, the system may include a printed guide, an associated webpage, or other instructional materials setting forth a method for sequentially learning the information on the cards 10. A first stage of learning may include focusing on the information in the second hole region 38 and memorizing the numerical and/or generic hole hand rank 48 (e.g., “good” or “very good.”). After a player has memorized the ranks of various hole card combinations, a second stage of learning may include focusing on the flop odds region 50 and memorizing the various hands to look for and the odds of those hands coming on the flop. After a player has memorized all the information in the second hole region 38, a third stage of learning may include focusing on the information in the second flop region 40, including memorizing the various hands to look for and the odds of those hands coming on the turn and on the turn/river. A final stage of learning may include focusing on the first and second nut hand regions 58, 66 and learning to recognize the nut hand for different combinations of flop and turn cards.

Although particular constructions of the present invention have been shown and described, other alternative constructions will be apparent to those skilled in the art and are within the intended scope of the present invention.

1. A set of training cards for learning the relative strength of hands in a card game, the set of training cards comprising:
a plurality of cards, each card having a first side and a second side, the first side of each card including a first hole card region including indicia corresponding to a pair of hole cards, a first flop card region including indicia corresponding to three flop cards, and a first turn card region including indicia corresponding to a turn card, and
the second side of each card including a second hole card region including the indicia corresponding to the pair of hole cards, a hole hand rank portion, and a flop hand odds portion, a second flop card region including the indicia corresponding to the three flop cards, a flop nut hand portion, a turn hand odds portion, and a turn/river hand odds portion, and a second turn card region including the indicia corresponding to the turn card, a turn nut hand portion, and a river hand odds portion,
wherein each of the plurality of cards includes indicia corresponding to different combinations of hole cards, flop cards, and turn cards.

2. The set of training cards of claim 1, further comprising at least one of a trivia question region, a vocabulary region, a quote region, a tip region, a trivia answer region, a poker fact region, a general information region, and a logo region.

3. The set of training cards of claim 2, wherein the vocabulary region is located in the second flop card region.

4. The set of training cards of claim 2, wherein the quote region, poker tip region, and trivia answer region are located in the second turn card region.

5. The set of training cards of claim 2, wherein the poker fact region is located in the second hole card region.

6. The set of training cards of claim 2, wherein the logo region, the poker trivia region, and the general information region are located in the first hole card region.

7. The set of training cards of claim 1, wherein the hole card rank portion includes at least one of a numerical representation and a written description of a relative strength of the pair of hole cards with respect to a remaining set of possible hole card combinations.

8. The set of training cards of claim 1, wherein the first side includes a plurality of card regions, each card region including a respective one of the indicia corresponding to the pair of hole cards, the three flop cards, or the turn card, and wherein the card regions resemble overlapping standard playing cards.

9. The set of training cards of claim 1, wherein the flop hand odds portion, the turn hand odds portion, the turn/river odds portion, and the river odds portion each display the odds of obtaining at least one hand on the flop, on the turn, on the turn or the river, and on the river, respectively, as at least one of a percentage and a probability.

10. The set of training cards of claim 9, wherein the flop hand odds portion, the turn hand odds portion, the turn/river odds portion, and the river odds portion each include the odds of obtaining at least one of a four of a kind, a full house, a straight, a flush, a three of a kind, a two pair, and a pair.

11. The set of training cards of claim 1, wherein a portion of the second flop card region extends below the second hole card region, and a portion of the second turn card region extends below the second flop card region and the second hole card region.

12. A set of training cards for learning the relative strength of hands in a card game, the set of training cards comprising:
a plurality of cards, each card having a first side and a second side, the first side of each card including a first hole card region including indicia corresponding to a hole card, a first flop card region including indicia corresponding to a flop card, and a first turn card region including indicia corresponding to a turn card, and
the second side of each card including a second hole card region including the indicia corresponding to the hole cards and a flop hand odds portion, a second flop card region including the indicia corresponding to the flop card, a turn hand odds portion, and a turn/river hand odds portion, and a second turn card region including the indicia corresponding to the turn card and a river hand odds portion,
wherein each of the plurality of cards includes indicia corresponding to different combinations of hole cards, flop cards, and turn cards.

13. The set of training cards of claim 12, wherein the first hole card region includes indicia corresponding to a pair of hole cards, and wherein the hole card rank portion includes at least one of a numerical representation and a written description of a relative strength of the pair of hole cards with respect to a remaining set of possible hole card combinations.

14. The set of training cards of claim 12, wherein the first side includes a plurality of card regions, each card region including a respective one of the indicia corresponding to the hole card, the flop card, or the turn card, and wherein the card regions resemble overlapping standard playing cards.

15. The set of training cards of claim 12, wherein the flop hand odds portion, the turn hand odds portion, the turn/river odds portion, and the river odds portion each display the odds of obtaining at least one hand on the flop, on the turn, on the turn or the river, and on the river, respectively, as at least one of a percentage and a probability.

16. The set of training cards of claim 15, wherein the flop hand odds portion, the turn hand odds portion, the turn/river odds portion, and the river odds portion each include the odds of obtaining at least one of a four of a kind, a full house, a straight, a flush, a three of a kind, a two pair, and a pair.

17. The set of training cards of claim 12, wherein a portion of the second flop card region extends below the second hole card region, and a portion of the second turn card region extends below the second flop card region and the second hole card region.

18. A set of training cards for learning the relative strength of hands in a card game, the set of training cards comprising:
a plurality of cards, each card having a first side and a second side, the first side of each card including a first hole card region including indicia corresponding to at least one hole card, and a dealt card region including indicia corresponding to at least one dealt card, and
the second side of each card including a second hole card region including the indicia corresponding to the at least one hole card and a dealt hand odds portion, and a second dealt card region including the indicia corresponding to the at least one dealt card and an additional dealt card odds portion,
wherein each of the plurality of cards includes indicia corresponding to different combination of hole cards and dealt cards.

19. The set of training cards of claim 18, wherein the first side of each card includes a first additional dealt card region including indicia corresponding to at least one additional dealt card, wherein the second side of each card includes a second additional dealt card region including the indicia corresponding to the at least one additional dealt card and another additional dealt card odds portion.

20. The set of training cards of claim 19, wherein a portion of the second dealt card region extends below the second hole card region, and a portion of the second additional dealt card region extends below the second dealt card region and the second hole card region.

21. The set of training cards of claim 18, wherein the second hole card region includes a hole card rank portion, and wherein the second dealt card region includes a nut hand portion.

22. The set of training cards of claim 21, wherein the hole card rank portion includes at least one of a numerical representation and a written description of a relative strength of the at least one hole card with respect to a remaining set of possible hole cards.
